(19) United States
(12) Patent Application Publication
(10) Pub. No.: US 2020/0264386 A1
(43) Pub. Date: Aug. 20, 2020

(54) MULTI-FIBER FERRULE WITH LENS ELEMENTS

(71) Applicant: Molex, LLC, Lisle, IL (US)

(72) Inventors: Malcolm H. Hodge, Lisle, IL (US); Russell K. Stiles, Lisle, IL (US)

(73) Assignee: Molex, LLC, Lisle, IL (US)

(21) Appl. No.: 16/347,198

(22) PCT Filed: Nov. 6, 2017
(86) PCT No.: PCT/US2017/060095

§ 371 Date: May 3, 2019

Related U.S. Application Data
(60) Provisional application No. 62/419,200, filed on Nov. 8, 2016.

(51) Int. Cl. G02B 6/38

(52) U.S. Cl. CPC G02B 6/3853; G02B 6/3885; G02B 6/3861; G02B 6/3839

(57) ABSTRACT

An optical lens plate includes a body having a front face and an oppositely facing rear face with a plurality of lenses adjacent the front face. A plurality of alignment sockets are disposed adjacent the rear face, with each alignment socket being aligned with one of the lenses and having a first end adjacent the rear face and a second end within the body. Each alignment socket includes a tapered lead-in section, a stop surface, and a lateral alignment section, with the stop surface defining the second end and the lateral alignment section having a non-tapering cross-section between the lead-in section and the stop surface. An optical transmission recess is disposed between one of the lenses and one of the alignment sockets and extends from the stop surface towards the front face of the body. An optical fiber assembly including a ferrule body and the lens plate is also disclosed.

### RELATED APPLICATIONS

This application claims to PCT Application No. PCT/US2017/060095, filed Nov. 6, 2017, which further claims priority to U.S. Provisional Application No. 62/419,200, filed Nov. 8, 2016, which are incorporated herein by references in their entirety.

### TECHNICAL FIELD

The present disclosure relates generally to optical fiber connector assemblies and, more particularly, to a multi-fiber ferrule with an adjacent lens structure.

### BACKGROUND

Systems for interconnecting optical fibers typically utilize mating ferrules to facilitate handling and accurate positioning of the fibers. The optical fibers are secured within the ferrule with an end surface of each fiber being positioned generally flush with or slightly protruding from an end face of the ferrule. The end surfaces or faces of the fibers are then polished to desired finish. When complementary ferrules are mated, each optical fiber of one ferrule is coaxially positioned with a mating optical fiber of the other ferrule.

In some applications, the end faces of the mating optical fibers physically contact one another in order to effect signal transmission between the mating optical fiber pair. In such applications, various factors may reduce the efficiency of the light transmission between the optical fiber pair such as irregularities, burrs or scratches in the fiber end faces, misalignment of the fibers as well as dust or debris between the fibers at the mating interface.

Due to the small optical path relative to the size of any foreign objects such as dust or debris, any such foreign objects will likely interfere with the transmission of light. Expanded beam connectors expand the width of the optical beam and transmit the beam over an air gap between the connectors. By expanding the beam, the relative size difference between the dust or debris and the beam is increased which thus reduces the impact of any dust or debris as well as any misalignment on the efficiency of the light transmission. As a result, expanded beam optical fiber connectors are often used in dirty and high vibration environments.

Expanded beam connectors include a lens mounted adjacent an end face of each fiber. Two types of lenses are commonly used—collimating and cross-focusing. A collimating lens receives the light from the fiber and expands the beam to a relatively large diameter. When using a collimating lens, a second lens and ferrule assembly are similarly configured with the lens positioned adjacent the end face of the second fiber for receiving the expanded beam, and refocuses the beam at the end face of the second fiber. A cross-focusing lens receives the light from the fiber, expands it to a relatively large diameter and then focuses the light from the relatively large diameter at a specific focal point. With cross-focusing lenses, the ferrule and lens assembly may be mated with either another ferrule and lens assembly having a cross-focusing lens or with a non-lensed ferrule as is known in the art. While lenses for alignment with a ferrule having a single optical fiber are typically spherical, lenses for alignment with multi-fiber ferrules are more complex in nature and tolerances typically must be controlled more tightly. Accordingly, it is desirable to provide a multi-fiber lensed ferrule and connector assembly that is less complex, easy to assemble and has improved performance.

The foregoing background discussion is intended solely to aid the reader. It is not intended to limit the innovations described herein, nor to limit or expand the prior art discussed. Thus, the foregoing discussion should not be taken to indicate that any particular element of a prior system is unsuitable for use with the innovations described herein, nor is it intended to indicate that any element is essential in implementing the innovations described herein. The implementations and application of the innovations described herein are defined by the appended claims.

### SUMMARY

In one aspect, an optical lens plate includes a body having a front face and an oppositely facing rear face with a plurality of lenses adjacent the front face. A plurality of optical fiber alignment sockets are disposed adjacent the rear face, with each optical fiber alignment socket being aligned with one of the lenses and having a first end adjacent the rear face and a second end within the body. Each optical fiber alignment socket includes a tapered lead-in section, a stop surface, and a lateral alignment section, with the stop surface defining the second end and the lateral alignment section having a non-tapering cross-section between the lead-in section and the stop surface. A plurality of optical transmission recesses are further provided with each optical transmission recess being disposed between one of the lenses and one of the alignment sockets and extending from the stop surface towards the front face of the body.

An optical fiber assembly includes a ferrule body, an alignment member, a lens plate and a plurality of optical fibers. The ferrule body has a forward face and an oppositely facing rearward face. The alignment member includes a plurality of alignment apertures, with each alignment aperture having a first tapered lead-in section and a first lateral alignment section aligned with each first lead-in section. Each first lateral alignment section has a non-tapering cross-section and the first lateral alignment sections of the plurality of alignment apertures define an alignment array. The lens plate has a body with a front face and an oppositely facing rear face, and a plurality of lens elements adjacent the front face. A plurality of optical fiber alignment sockets are disposed adjacent the rear face, with each optical fiber alignment socket being aligned with one of the lens elements and having a first end and a second end within the body. Each optical fiber alignment socket includes a second tapered lead-in section, a stop surface, and a second lateral alignment section. The stop surface defines the second end and the second lateral alignment section has a non-tapering cross-section between the second lead-in section and the stop surface. The lens plate further includes a plurality of optical transmission recesses, with each optical transmission recess extending from the stop surface towards the front face of the body. The lateral alignment sections of the plurality of optical fiber alignment sockets defining a socket array corresponding to the alignment array. The plurality of optical fibers are positioned so that each optical fiber extends through one of the first lateral alignment sections of the alignment member and is disposed within one of the second lateral alignment sections of the plurality of optical fiber alignment sockets of the lens plate. An optically transmitting medium is disposed within each optical transmission recess.

### BRIEF DESCRIPTION OF THE DRAWINGS

FIG. 1 is a perspective view of a portion of an optical fiber cable assembly;

FIG. 2 is a sectional view taken generally along line 2-2 of FIG. 1;

FIG. 3 is an enlarged fragmented view of a portion of FIG. 2;

FIG. 4 is an exploded perspective view of the portion of the optical fiber assembly of FIG. 1;

FIG. 5 is a perspective view of the ferrule body of the optical fiber cable assembly of FIG. 1;

FIG. 6 is a sectional view taken generally along line 6-6 of FIG. 5;

FIG. 7 is an enlarged fragmented view of a portion of FIG. 6;

FIG. 8 is a perspective view of the pre-alignment member of the optical fiber cable assembly of FIG. 1;

FIG. 9 is a perspective view of the pre-alignment member of FIG. 8 from a rear perspective;

FIG. 10 is a sectional view taken generally along line 10-10 of FIG. 8;

FIG. 11 is a perspective view of the lens plate of the optical fiber cable assembly of FIG. 1;

FIG. 12 is a perspective view of the lens plate of FIG. 11 from a rear perspective;

FIG. 13 is a sectional view taken generally along line 13-13 of FIG. 11 with a pair of optical fibers added for clarity;

FIG. 14 is an enlarged fragmented view of a portion of FIG. 13

FIG. 15 is a fragmented rear perspective view of a portion of the lens plate with certain optical fibers added for clarity;

FIG. 16 is a perspective view of a plurality of optical fibers loaded into the pre-alignment member of FIG. 6;

FIG. 17 is a sectional view taken generally along line 17-17 of FIG. 16;

FIG. 18 is a perspective view of the optical fibers and pre-alignment member loaded into the ferrule body of FIG. 5;

FIG. 19 is a sectional view taken generally along line 19-19 of FIG. 18;

FIG. 20 is a perspective view of the optical fiber, pre-alignment member, and ferrule body assembly with the optical fibers cleaved to a desired length;

FIG. 21 is a sectional view taken generally along line 21-21 of FIG. 20; and

FIG. 22 is an enlarged fragmented view of a portion of FIG. 14 with an optical fiber inserted therein.

### DETAILED DESCRIPTION

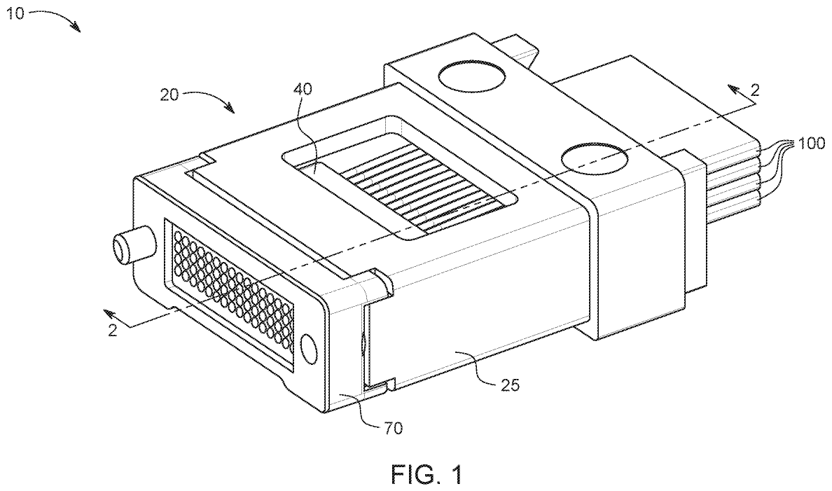

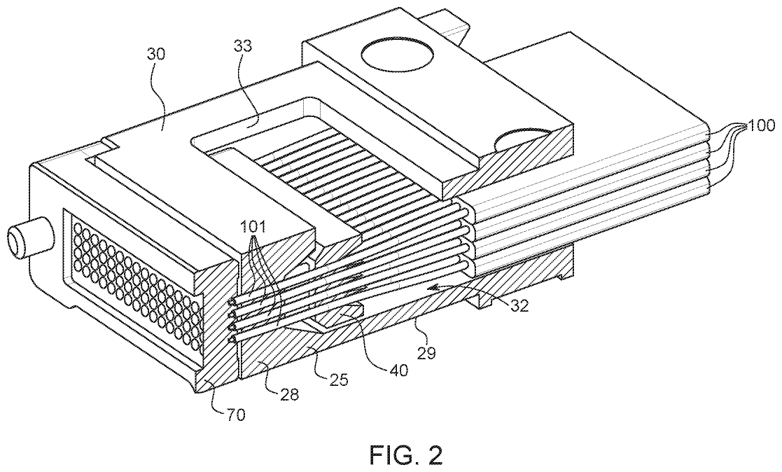

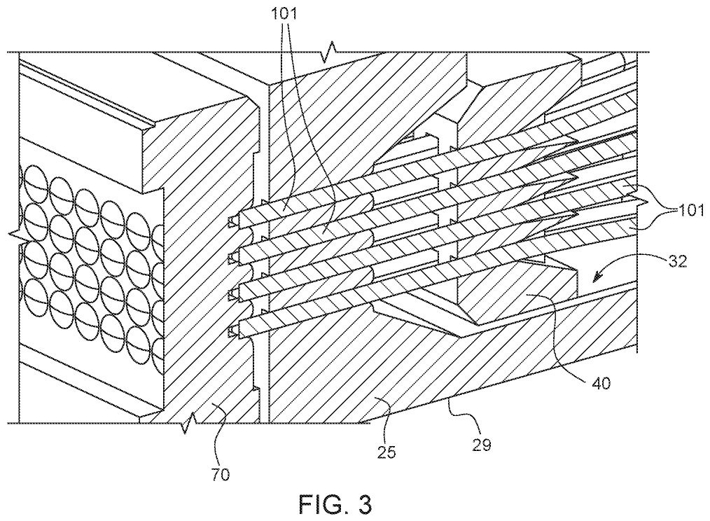

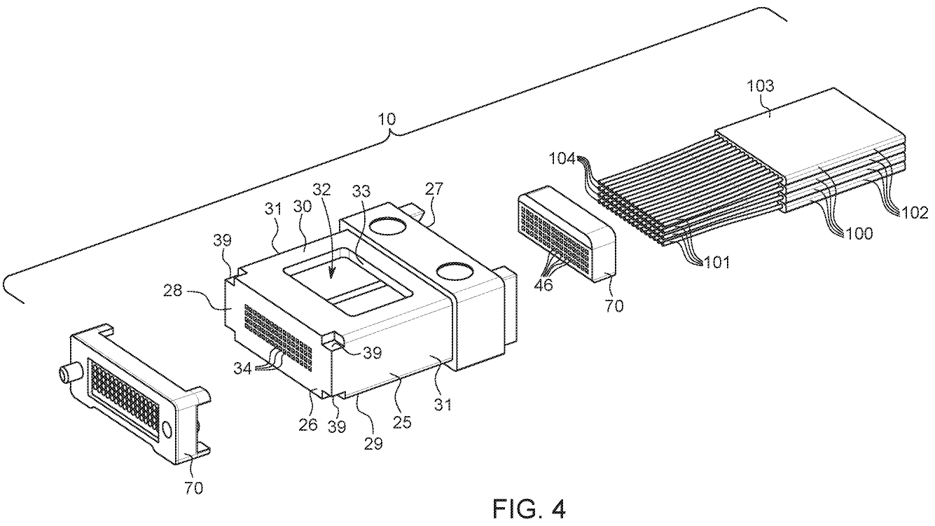

Referring to FIGS. 1-4, a multi-fiber lensed connector assembly 10 includes a ferrule assembly 20 with a plurality of multi-fiber ribbon cables 100 that each includes a plurality of optical fibers 101 disposed therein. The ferrule assembly 20 includes a ferrule body 25, a pre-alignment member 40, and a beam expanding element such as lens plate 70.

Each ribbon cable 100 includes a plurality of optical fibers 101 that are positioned generally side-by-side to form a generally planar, flexible ribbon 102. The ribbon 102 may include internal components (not shown) surrounding the optical fibers 101 such as strength members and binders together with an outer jacket 103 that surrounds the internal components. The optical fibers 101 may be any type, such as the single mode depicted. In other embodiments, the optical fibers 101 may have other configurations such as multi-mode fibers. In the depicted embodiment, the optical fibers may have an outer diameter of approximately 125 μm and a core (not shown) having a diameter of approximately 9 μm that extends along a central axis of the optical fiber.

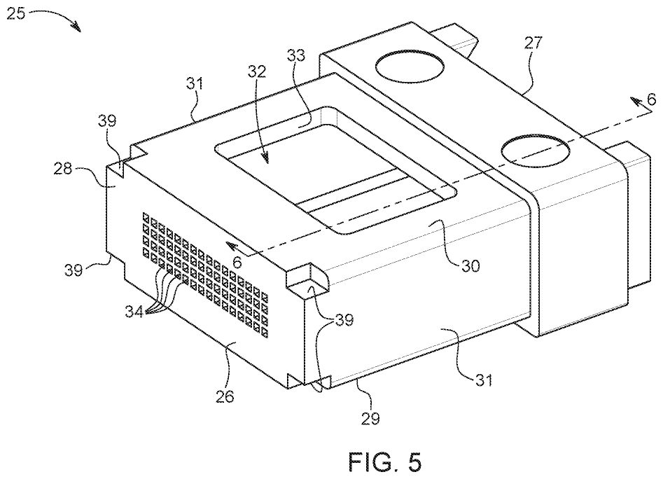

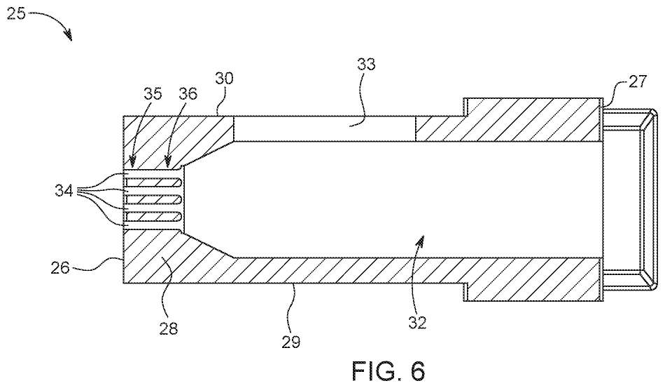

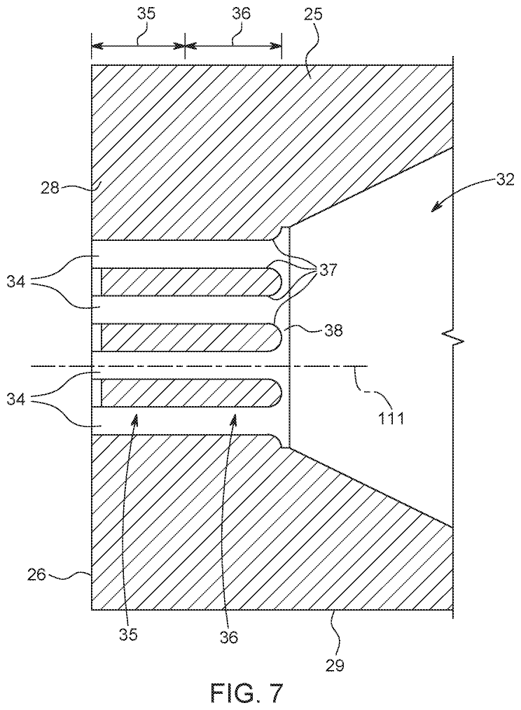

Referring to FIGS. 5-7, ferrule body 25 is generally rectangular and has a forward face 26 and an oppositely facing rearward face 27. The ferrule body 25 includes a front wall 28, a lower wall 29, an upper wall 30, and a pair of sidewalls 31 that interconnect the lower wall and upper wall. A generally rectangular, elongated cavity 32 extends from the rearward face 27 towards the forward face 26. The upper wall 30 may include an opening 33 through which an adhesive such as epoxy may be inserted into the ferrule assembly 20 during the manufacturing process.

The front wall 28 includes a plurality of alignment apertures 34 that extend through the front wall from the forward face 26 to the cavity 32. The alignment apertures 34 may be configured in any desired array. As depicted, the array includes four rows of sixteen apertures 34. Each aperture 34 includes a forward or lateral alignment section 35 and a rearward or tapered lead-in section 36. Each forward section 35 extends from the forward face 26 rearward towards the cavity 32. Each forward section 35 includes pairs of parallel walls to define a square, non-varying cross-section along its entire length that operates to laterally align an optical fiber 101 inserted therein. In other words, the forward section 35 has a consistent cross-section that does not taper.

It should be noted that some conventional components may be molded with what appears to be one or more non-tapering openings or apertures but such openings or apertures are actually slightly tapered to assist in molding the component. Such tapering or draft is typically a very small angle such as 1-2°. In some applications, the draft angle may be smaller. The forward section 35 of aperture 34 may be configured so that its cross-section does not include a draft and thus has zero taper or angle. As used herein, a non-tapering cross-section is one in which the angle between the surfaces or the angle of any such taper is less than approximately ¼°.

In one embodiment, the sides of each square cross-section or the distance across the forward section 35 of each aperture 34 may be approximately 5-10 microns larger than the 125 μm diameter of the optical fiber 101 (e.g., 130-135 μm). In another embodiment, the distance across the forward section 35 may be approximately 3-10 μm larger than the diameter of the optical fiber 101. In other embodiments, the distance across the forward section 35 of each aperture 34 may be set at between 4-8% larger than the diameter of the optical fiber 101.

The cross-sectional size of the forward section 35 of aperture 34 may be dependent upon the depth or length of the forward section. As used herein, the depth of a component may be referring to its dimensions along an axis parallel to the axes along which light travels such as axes 106 of the optical fibers 101 and the optical axes 110 through the lens plate 70. For example, as depicted, the forward section 35 of aperture 34 may have a cross-sectional dimension of 130-135 μm. In such case, it may be desirable to configure the forward section 35 to have a depth of at least 0.5 mm. Such configuration will result in the axes 105 of the optical fibers 101 being within 1° of parallel to the optical axes 111 through forward sections 35. By accurately aligning and positioning the optical fibers 101 with the apertures 34, insertion of the ends 104 of the optical fibers into highly precise alignment sockets 76 in lens plate 70 is simplified.

In another example, the axes 105 of the optical fibers 101 may be maintained at an angular alignment of less than 1° of angular offset from the optical axes 111 through forward sections 35 with the forward section having a cross-sectional dimension of approximately 177 μm and a depth of approximately 3.0 mm. Other configurations are contemplated that will result in a similar angular alignment. For example, a similar angular alignment may be achieved with a forward section 35 having a depth of approximately 1.0 mm and a cross-sectional dimension larger than 135 μm but less than 177 μm.

In instances in which the optical fibers 101 are multi-mode rather than single mode, the accuracy of angular and lateral alignment of the optical fibers may be reduced. In such case, the cross-sectional dimension of the forward sections 35 may be increased and/or the depth of the forward section reduced.

The rearward section 36 of each aperture 34 extends from the cavity 32 to the forward section 35 of the aperture. The rearward section 36 tapers or narrows so that it is widest adjacent the cavity 32 and narrowest adjacent forward section 35 to facilitate insertion of ends 104 of the optical fibers 101 therein. The rearward section 36 of each aperture 34 is defined by a pair of spaced apart tapered horizontal walls 37 and a pair of spaced apart tapered vertical walls 38.

Alignment notches or recesses 39 may be provided in each of the corners formed at the intersections of front wall 28 with the lower walls 29, upper wall 30, and sidewalls 31. The alignment recesses 39 may interact with alignment legs 98 that extend from the rear face 72 of the lens plate 70.

Ferrule body 25 may be formed of any desired material. In one example, the ferrule body 25 may be formed of a material such as Ultem® that is dimensionally stable and may be molded. In some applications, it may be desirable for the ferrule body 25 to be formed of a material that is transparent to ultraviolet light such as polysulfone to facilitate the use of ultraviolet curable adhesives within the ferrule body.

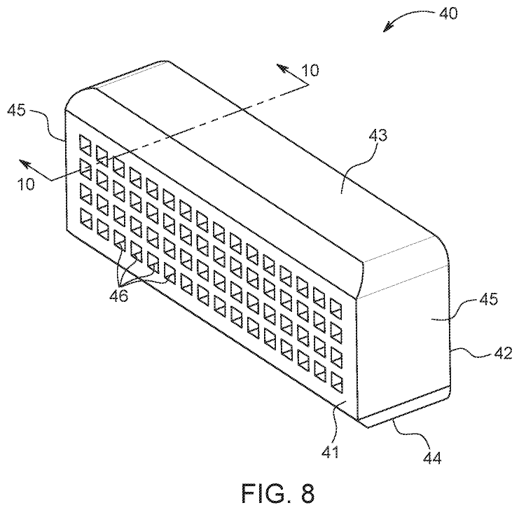

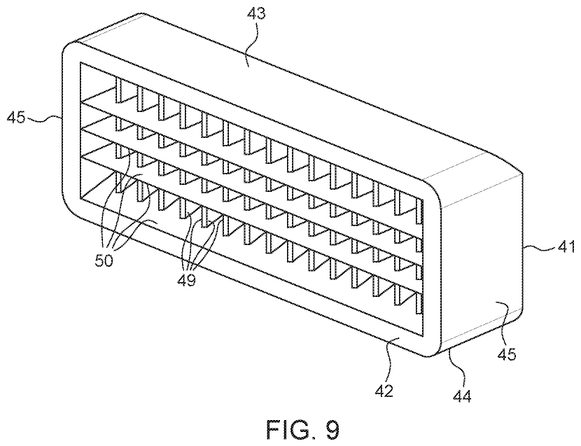

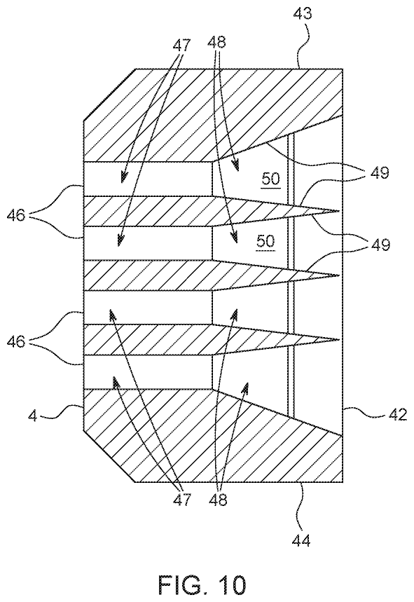

Ferrule assembly 20 may include a fiber holder or pre-alignment member 40 disposed within cavity 32. Referring to FIGS. 8-10, pre-alignment member 40 is generally rectangular and includes a front end 41, a rear end 42, a top wall 43, a bottom wall 44, and a pair of sidewalls 45 that interconnect the top and bottom walls. The top wall 43, bottom wall 44, and sidewalls 45 define an outer perimeter that is slightly smaller than the cross-section of cavity 32 to permit the pre-alignment member 40 to be inserted into the cavity. The cross-section of the pre-alignment member 40 may be sized or configured relative to the cross-section of cavity 32 to reduce the likelihood that the pre-alignment member will become skewed or off-axis while inserting the pre-alignment member into the cavity.

In some embodiments, the pre-alignment member 40 may be configured to hold the optical fibers 101 generally in desired positions to assist in managing them for insertion into apertures 34 in ferrule body 25. In other embodiments, the pre-alignment member may be configured to accurately align or position the optical fibers for insertion into the alignment sockets 76 of lens plate 70 and the apertures 34 in ferrule body 25 (or the precision alignment aspect of such apertures) may be eliminated.

The pre-alignment member 40 may include a plurality of alignment apertures 46 that extend through the pre-alignment member from front side 41 to rear side 42 and may be configured in the same manner as the alignment apertures 34 of the ferrule body 25. More specifically, the alignment apertures 46 may be configured in any desired array and in many embodiments, the array may match that of the ferrule body 25. Accordingly, as depicted, the array includes four rows of sixteen apertures 45.

The arrays of the alignment apertures 34 of ferrule body 25 and alignment apertures 46 of pre-alignment member 40 may not be identical but each aperture having an optical fiber 101 extending therethrough is aligned with an aperture of the other component. In other words, it is not necessary to have a one-to-one correspondence between apertures 34 of ferrule body 25 and apertures 46 of pre-alignment member 40 but each aperture of the pre-alignment member having an optical fiber 101 therein is aligned with an aperture of the ferrule body. In some instances, it may be desirable to utilize a ferrule body with many or all possible apertures and configure the pre-alignment member 40 to only include those apertures that will actually include optical fibers 101 therein. By maximizing the number of apertures in the ferrule body, the ferrule body may operate as a “uniform” or “standard” ferrule body configured to receive many different types or configurations of pre-alignment members.

In one embodiment, each aperture 46 of pre-alignment member 40 includes a forward or lateral alignment section 47 and a rearward or tapered lead-in section 48. The forward section 47 extends from the front end 41 of pre-alignment member 40 rearward towards the rear end 42. In some embodiments, the forward section 47 of pre-alignment member 40 may be configured with identical or substantially similar dimensions or configuration as the forward section 35 of apertures 34 of ferrule body 25 and the description thereof is not repeated.

The rearward section 48 of aperture 48 extends from forward section 47 to the rear end 42 of the pre-alignment member 40. The rearward section 48 tapers or narrows in all directions from the rear end 42 towards the forward section 47 to facilitate insertion of ends 104 of the optical fibers 101 therein. The rearward section 48 of each aperture 45 is defined by a pair of spaced apart tapered horizontal walls 49 and a pair of spaced apart tapered vertical walls 50.

Pre-alignment member 40 may be formed of any desired material. In one example, the pre-alignment member 40 may be formed of a material such as Ultem® that is dimensionally stable and may be molded. In some applications, it may be desirable for the pre-alignment member 40 to be formed of a material that is transparent to ultraviolet light such as polysulfone to facilitate the use of ultraviolet curable adhesives within the ferrule assembly 20. In other applications, it may be desirable to utilize a portion of pre-alignment member 40 as a strain relief for the optical fibers 101. In such case, it may be desirable to form the pre-alignment member 40 from a material having some flexibility.

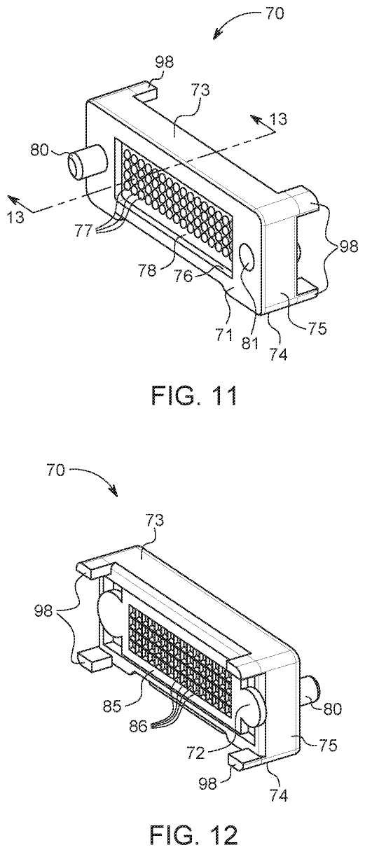

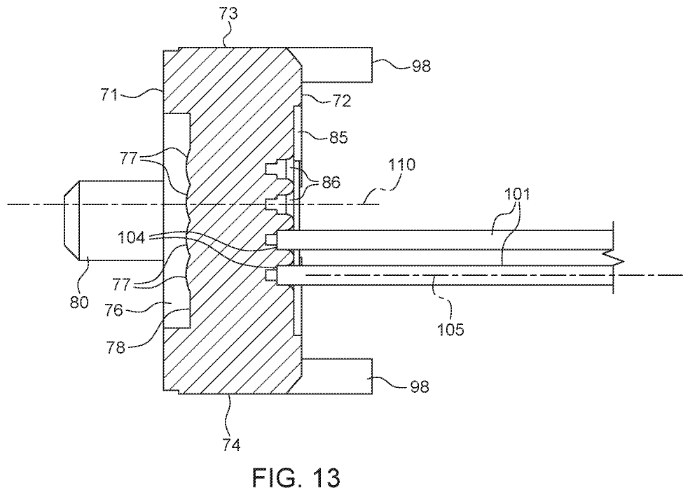

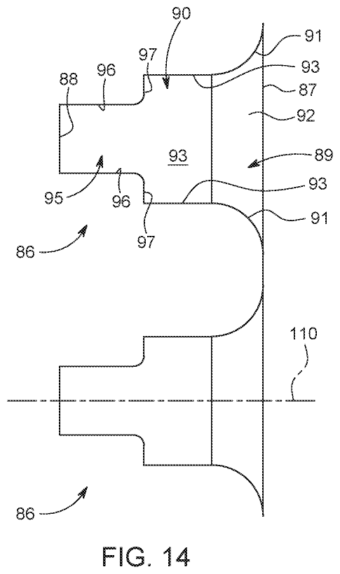

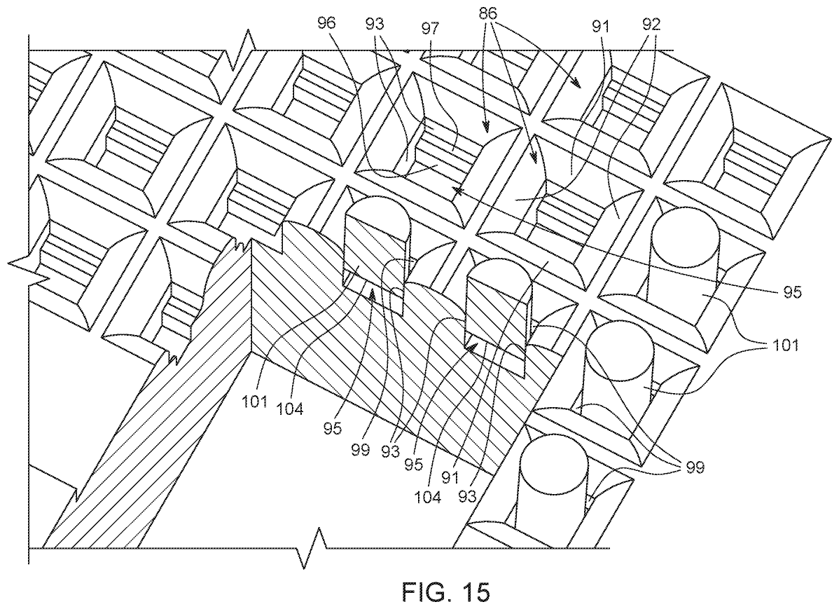

Referring to FIGS. 11-15, lens plate 70 is generally rectangular and has a front face 71, an oppositely facing rear face 72, a top wall 73, a bottom wall 74, and a pair of sidewalls 75. A recess 76 may be generally centrally located in front face 71 and includes a plurality of lens elements 77. The lens elements 77 may be configured in any desired array. As depicted, the array includes four rows of sixteen lens elements 77 to match the array of apertures 34 of ferrule body 25.

Lens elements 77 may be any type of lens such as collimating or cross-focusing. In the depicted embodiment, the lens elements 77 have a convex shape projecting from an inner surface 78 of recess 76. The front face 71 of lens plate 70 may also include an alignment structure for aligning a pair of mating connector assemblies 10. As depicted, the alignment structure includes an alignment post 80 positioned between the recess 76 and one of the sidewalls 75. A cylindrical alignment or guide hole 81 is positioned between the recess 76 and the opposite side wall 75. The guide hole 81 is dimensioned to receive the alignment post 80 therein. The alignment post 80 and the guide hole 81 are positioned the same distance between the top wall 73 and bottom wall 74 in the same distance from the sidewalls 75 to facilitate mating with another connector assembly 10 having an identically configured lens plate 70.

Rear face 72 includes a generally centrally located recess 85 having a plurality of optical fiber alignment sockets 86. Each of the alignment sockets 86 is aligned along an optical axis 110 with one of the lens elements 77 along the front face 71 so that the array of alignment sockets matches the array of lens elements. Accordingly, the array of alignment sockets 86 includes four rows of sixteen alignment sockets. By aligning the lens elements 77 with the alignment sockets 86, light passing in a first direction through the lens plate 70 from an optical fiber 101 in an alignment socket will be received at its aligned lens element 77 and light passing in a second direction through the lens plate from the lens element will be focused at the optical fiber on the aligned alignment socket.

Each alignment socket 86 has a first end 87 adjacent the rear face 72 and a second end 88 within the lens plate 70 so that the alignment socket extends generally from the rear face 72 towards the front face 71. The alignment socket 86 includes a tapered lead-in section 89 generally adjacent the rear face 72 and a lateral alignment section 90 that extends from the lead-in section 89 to the second end 88. The tapered lead-section 89 of each alignment socket 86 is defined by a pair of spaced apart tapered first walls 91 and a pair of spaced apart tapered second walls 92.

The lateral alignment section 90 includes pairs of parallel walls 93 to define a square, non-varying cross-section along its entire length. In other words, the alignment section 90 has a consistent cross-section that does not taper (i.e., tapers less than) ¼° as described above with respect to forward section 35 of aperture 34 of ferrule body 25. In one embodiment, the sides of each square cross-section or the distance across each alignment section 90 may be between approximately 123 and 127 μm. In another embodiment, the sides or distance across each alignment section 90 may be approximately equal to the diameter of the optical fiber ±1.2%.

The configuration of the alignment section 90 permits the axis 105 of an optical fiber 101 inserted therein to be accurately aligned with an optical axis 110 defined as extending through a lens elements 77 and a lateral alignment section 90. Such accurate alignment is in both lateral (i.e., x and y) directions and angularly. The lateral alignment section 90 permits the axis 105 of an optical fiber 101 inserted into the alignment section to be laterally aligned within 1.5 μm of the optical axis through the lens plate 70. In other embodiments, the axis 105 of optical fibers 101 may be laterally offset from an optical axis through the lateral alignment section 90 by less than approximately 1.2% of the diameter of the optical fibers.

In addition, the lateral alignment section 90 permits an optical fiber 101 inserted therein to be aligned within approximately 1° of the optical axis 110 extending through the lateral alignment section 90 and its associated lens elements 77. In other words, the lateral alignment section 90 is configured so that the axis 105 of an optical fiber inserted into the lateral alignment section is within 1° of being parallel to the optical axis 110.

As depicted, the lateral alignment section 90 of alignment socket 86 may be at least approximately 65 μm deep or long. In other embodiments, the depth of the alignment section 90 may be between 40 and 150 μm. In still other embodiments, the depth of the alignment section 90 may be at least approximately ⅓ of the diameter of the optical fibers 101. In still a further embodiment, the depth of the alignment section may be at least approximately ½ of the diameter of the optical fibers 101. In some embodiments, it may be desirable for the alignment section 90 have a depth greater than or deeper than the depth of the tapered lead-in section.

An optical transmission recess or well 95 may be formed at an end of each alignment section 90 and extend towards the front face 71 of lens plate 70 and define the second end 88 of the alignment socket 86. The optical transmission recess 95 may have a pair of spaced apart sidewalls 96 that are closer together than the first walls 91 and the second walls 92 of the alignment section 90 in order to define a pair of spaced apart shoulders 97. The shoulders 97 may operate as stop surfaces to define the lower or inner limit of the alignment section 90. Although the shoulders 97 are depicted as extending entirely across two opposite sides of the alignment socket 86 or between the second walls 92, other configurations are contemplated. For example, the shoulders 97 may not extend entirely between the second wall 92 of the alignment socket 86 or they may extend along all or part of two or more sides of the alignment socket.

The shoulders 97 operate to establish a limit as to how far the ends 104 of optical fibers 101 may be inserted into the alignment socket 86 and thus define the depth of the optical transmission recess 95. In one embodiment, the optical transmission recess 95 may be approximately 80 μm deep. In other embodiments, the depth of the optical transmission recess 95 may be set between approximately 30 and 150 μm. In still another embodiment, the depth of the optical transmission recess 95 may be between approximately 50 and 150 μm deep. In a further embodiment, the depth of the optical transmission recess 95 may be between approximately 60 and 100 μm deep. In still a further embodiment, the depth of the optical transmission recess 95 may be between approximately 50 and 1000 μm deep. In still other embodiments, the optical transmission recess 95 may be eliminated.

The optical transmission recess 95 may be filled with an optically transmitting medium with a desired refractive index. In some instances, it may be desirable to select an optically transmitting medium having a refractive index that matches or approximately matches the refractive index of the lens plate 70, the refractive index of the optical fibers 101, or has a refractive index between the refractive index of the lens plate and the refractive index of the optical fibers. In general, the depth of the optical transmission recesses 95 may approximate the distance between the second end 88 of alignment socket 86 and the ends 104 of optical fibers 101. In many instances, all of the optical fibers 101 will not have identical lengths. Regardless of the length of each optical fiber 101, the optically transmitting medium will fill the gap between the second end 88 of each alignment socket 86 and the end 104 of the optical fiber inserted therein.

An alignment leg 98 may be provided at each corner of the rear face 72 of lens plate 70. The alignment legs 98 may interact with alignment recesses 39 formed in the front wall 28 of ferrule body 25.

Although depicted as having a square cross-section, the alignment socket 86 may have any desired configuration including a round cross-section. By configuring the alignment socket 86 with a square cross-section and the optical fiber 101 with a round cross-section, a path or channel 99 is provided for excess adhesive or another optically transmitting medium inserted into the alignment socket and the optical transmission recess 95. More specifically, adhesive or another optically transmitting medium may be inserted into the alignment socket 86 and optical transmission recess 95. Upon inserting an end 104 of an optical fiber 101 into the alignment socket 86, excess adhesive or optically transmitting medium may be displaced from the alignment section 90 of alignment socket 86 and travel along the space 99 at the corners of the alignment socket between optical fiber and the corners. Without such paths, the adhesive or optically transmitting medium may prevent the end 104 of the optical fiber 101 from being fully inserted into the alignment socket 86. If the alignment sockets have other configurations, paths may still be provided to permit the egress of excess adhesive or optically transmitting medium from the alignment section of the alignment sockets.

Lens plate 70 may be formed of any optical grade resin or other material capable of being formed or configured in the desired shape. In one example, the lens plate 70 may be formed of by injection molding a material having a refractive index closely matching that of the optical fibers 101.

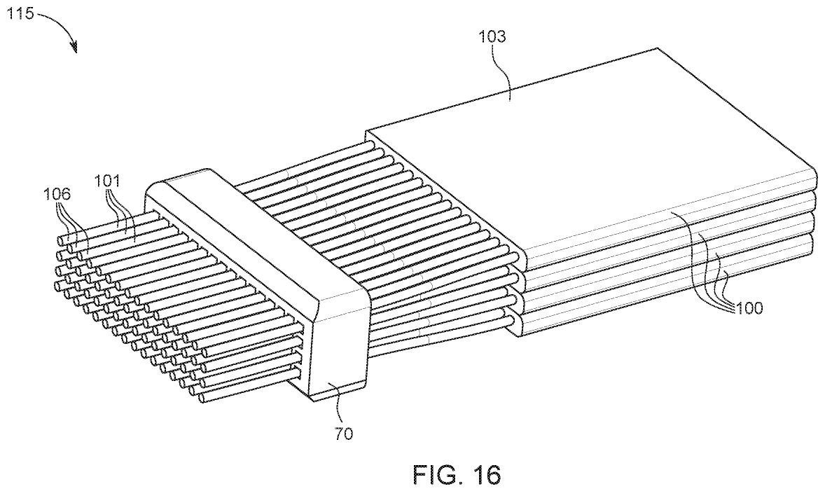

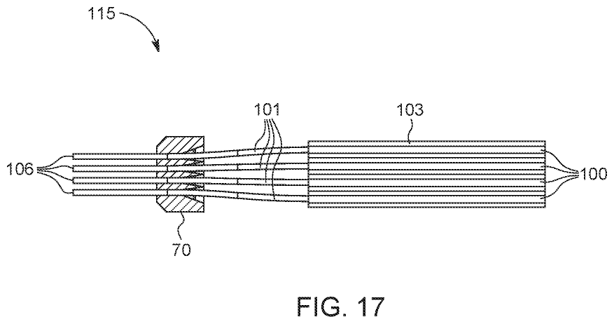

The multi-fiber lens connector assembly 10 may be manufactured by any desired process. In one embodiment, a multi-fiber lens connector assembly 10 may be manufactured by removing the outer jacket 103 from a length of flexible ribbon 102. In addition, internal components (not shown) that surround the optical fibers 101 may also be removed to leave an exposed length of the optical fibers. In one embodiment, the bare optical fibers 101 may be inserted into the alignment apertures 46 of pre-alignment member 40. To do so, the uncleaved ends 106 of the optical fibers 101 are inserted from the rear side 42 of the pre-alignment member 40 into the rearward section 48 of the alignment apertures 46 and then into and through the forward section 47. Once inserted, the pre-alignment member 40, the optical fibers 101, and the ribbons 102 form a subassembly 115 depicted in FIGS. 16-17.

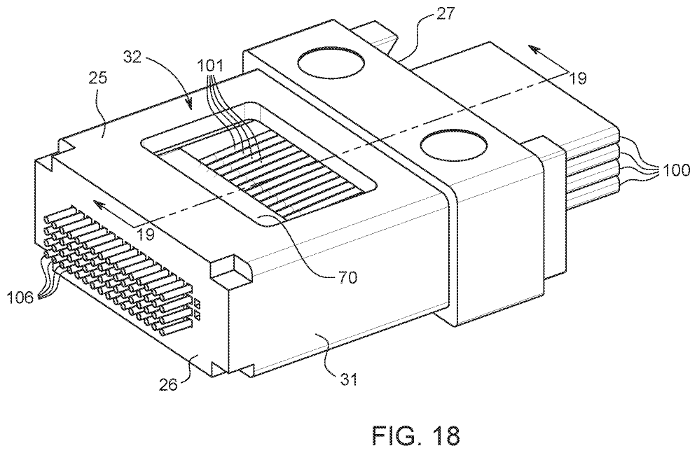

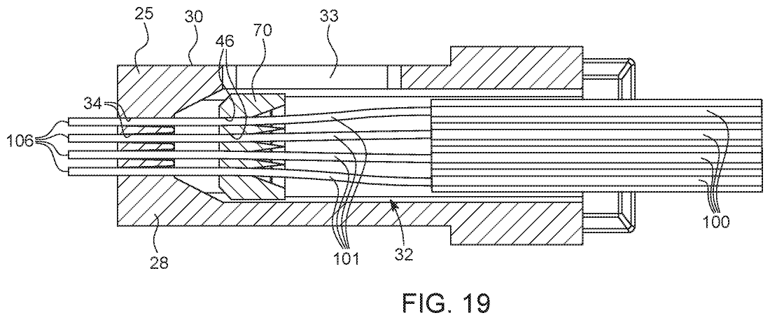

The subassembly 115 including the uncleaved ends 106 are inserted past the rearward face 27 of ferrule body 25 and into cavity 32. The subassembly 115 is moved through cavity 32 towards the front wall 28 of the ferrule body 25. The uncleaved ends 106 of the optical fibers 101 are aligned with the alignment apertures 34 that extend through the front wall 28. The subassembly 115 may be inserted into the cavity 32 of the ferrule body 25 until the uncleaved ends 106 of the optical fibers 101 extend from or past the forward face 26 of the ferrule body a predetermined distance as depicted in FIGS. 18-19. The ribbons 102 extend rearwardly out of the cavity 32 of ferrule body 25.

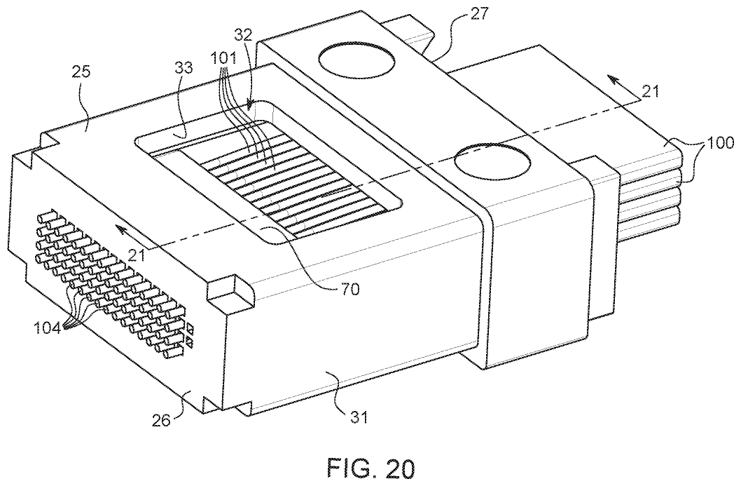

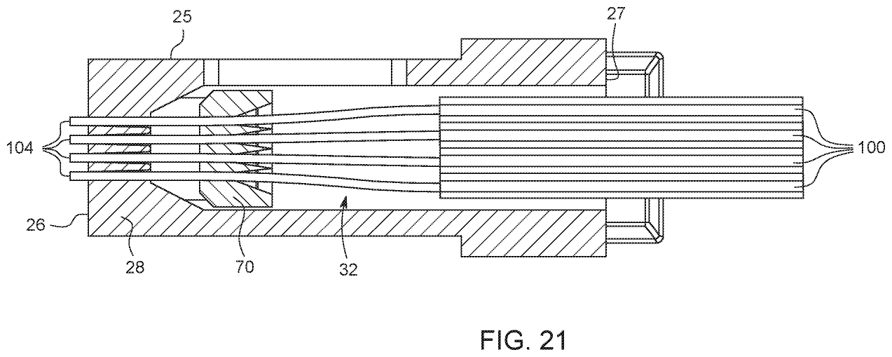

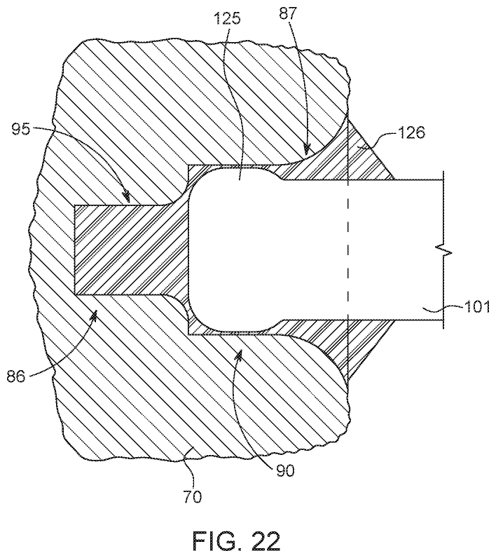

After inserting the optical fibers 101 through apertures 34 in ferrule body 25, the uncleaved ends 106 of the optical fibers may be cut or cleaved in any desired manner to the desired length to form ends 104. In some embodiments, the optical fibers 101 may be mechanically or laser cleaved. As may be seen in FIGS. 20-21, the optical fibers 101 are shorter than those depicted in FIGS. 18-19.

An adhesive such as an ultraviolet curable epoxy having a desired refractive index may be applied to the alignment sockets 86 including at the rear face 72 of lens plate 70. An adhesive may also be applied to the recesses 39 in the front wall 28 of ferrule body 25. The lens plate 70 may be aligned relative to the forward face 26 of ferrule body 25 so that the alignment legs 98 at the rear face 72 of lens plate 70 are aligned with the recesses 39 in the front wall 28 of ferrule body. The lens plate 70 may be moved relatively towards the forward face 26 of ferrule body 25 so that the alignment legs 98 enter the recesses 39 in the front wall 28 of the ferrule body 25. Continued movement of the rear face 72 of lens plate 70 towards the forward face 26 of the ferrule body 25 will result in the ends 104 of optical fibers 101 approaching the alignment sockets 86. As the lens plate 70 continues to move towards the ferrule body 25, the ends 104 of optical fibers 101 will engage the tapered lead-in sections 89 of each alignment socket 86 and be guided into the alignment sections 90 as depicted in FIGS. 1-3. Excess adhesive within the alignment sockets 86 may be displaced along the space or channels 99 at the corners of the alignment sockets between the optical fibers and the corners of the sockets.

Adhesive may also be applied to other portions of ferrule body 25 and the optical fibers 101 such as through the opening 33 in the upper wall 30 of the ferrule body 25. The adhesive may generally fill cavity 32 to create a generally solid structure after the adhesive has been cured. If ultraviolet curable adhesive such as epoxy is used, the curing may be achieved by providing an ultraviolet light source.

Various alternatives to the embodiment depicted in the drawings are contemplated. For example, in some applications, rather than utilizing an adhesive within the alignment sockets 86 and optical transmission recesses 95, a medium having a desired refractive index may be used. In such case, an adhesive may be applied to other portions of the ferrule body 25 and lens plate 70 to secure the two components together. In one example, a medium having a desired refractive index may be applied to the alignment sockets 86 and optical transmission recesses 95 and an adhesive applied to the alignment recesses 39 in the front wall of ferrule body 25. In another example, the optical fibers 101 and ribbons 102 may be inserted into the cavity 32 with ends 104 of the optical fibers inserted through the alignment apertures 34 in the front wall 28 without the use of pre-alignment member 40.

Referring to FIG. 22, in yet another embodiment, the optical fibers 101 may be laser cleaved in such a manner so as to create a “match-head” type of bulge 125 at its proximal tip. In one embodiment, the resulting bulge 125 is dimensioned so that its diameter generally matches the distance across the lateral alignment section 90 of the lens plate 70. In another embodiment, the diameter of the bulge 125 may be slightly larger than the distance across the lateral alignment section 90. If the diameter of the bulge 125 is greater than the distance across the lateral alignment section 90, the bulge may skive into the side walls 93 of the alignment section as the lens plate will typically be formed of a softer material than that of the optical fibers. The skiving of the bulge 125 into the side walls 93 may increase the retention of the optical fibers 101 within the alignment sockets 86.

In addition, the bulge 125 may have an axial length shorter than the axial length of the alignment socket 86. In such case, upon applying an adhesive 126 such as epoxy with the socket 86, a mechanical key or interference between bulge 125 and the adhesive will reduce the potential for fiber-to-lens delamination during environmental cycling. As long as the fiber tip bulge 125 is smaller in cross-section than the cross-sectional dimensions of the forward section 35 of each aperture 34, the bulge will not negatively impact the assembly of the multi-fiber lensed connector assembly 10.

It will be appreciated that the foregoing description provides examples of the disclosed system and technique. However, it is contemplated that other implementations of the disclosure may differ in detail from the foregoing examples. All references to the disclosure or examples thereof are intended to reference the particular example being discussed at that point and are not intended to imply any limitation as to the scope of the disclosure more generally. All language of distinction and disparagement with respect to certain features is intended to indicate a lack of preference for those features, but not to exclude such from the scope of the disclosure entirely unless otherwise indicated.

Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context.

Accordingly, this disclosure includes all modifications and equivalents of the subject matter recited in the claims appended hereto as permitted by applicable law. Moreover, any combination of the above-described elements in all possible variations thereof is encompassed by the disclosure unless otherwise indicated herein or otherwise clearly contradicted by context.

1. An optical lens plate comprising:
a body having a front face and an oppositely facing rear face;
a plurality of lenses adjacent the front face;
a plurality of optical fiber alignment sockets adjacent the rear face, each optical fiber alignment socket being aligned with one of the lenses and having a first end adjacent the rear face and a second end within the body, each optical fiber alignment socket including a tapered lead-in section, a stop surface, and a lateral alignment section, the stop surface defining the second end and the lateral alignment section having a non-tapering cross-section between the lead-in section and the stop surface; and
a plurality of optical transmission recesses, each optical transmission recess being disposed between one of the lenses and one of the alignment sockets and extending from the stop surface towards the front face of the body.

2. The optical lens plate of claim 1, wherein each lateral alignment section has a square cross-section.

3-4. (canceled)

5. The optical lens plate of claim 1, wherein each alignment socket includes at least one channel along the alignment section configured to permit an optically transmitting medium to pass therethrough.

6. The optical lens plate of claim 5, wherein each lateral alignment section has a square cross-section and the at least one channel is along a corner of the lateral alignment section.

7. The optical lens plate of claim 1, wherein a distance across a cross-section of each lateral alignment section is between approximately 123 and 127 μm.

8. The optical lens plate of claim 1, wherein each lateral alignment section has a depth of at least approximately 65 μm.

9-12. (canceled)

13. The optical lens plate of claim 1, wherein the lead-in section is adjacent the rear face of the body, and the lateral alignment section extends from the lead-in section to the stop surface.

14. The optical lens plate of claim 13, wherein the lateral alignment section is deeper than the lead-in section.

15. An optical fiber assembly comprising:
a ferrule body having a forward face and an oppositely facing rearward face;
an alignment member including a plurality of alignment apertures, each alignment aperture having a first tapered lead-in section and a first lateral alignment section aligned with each first lead-in section, each first lateral alignment section having a non-tapering cross-section, the first lateral alignment sections of the plurality of alignment apertures defining an alignment array;
a lens plate having a body with a front face and an oppositely facing rear face, a plurality of lens elements adjacent the front face, a plurality of optical fiber alignment sockets adjacent the rear face, each optical fiber alignment socket being aligned with one of the lens elements and having a first end and a second end within the body, each optical fiber alignment socket including a second tapered lead-in section, a stop surface, and a second lateral alignment section, the stop surface defining the second end and the second lateral alignment section having a non-tapering cross-section between the second lead-in section and the stop surface, and a plurality of optical transmission recesses, each optical transmission recess extending from the stop surface towards the front face of the body, the lateral alignment sections of the plurality of optical fiber alignment sockets defining a socket array corresponding to the alignment array;
a plurality of optical fibers, each optical fiber extending through one of the first lateral alignment sections of the alignment member and being disposed within one of the second lateral alignment sections of the plurality of optical fiber alignment sockets of the lens plate; and
an optically transmitting medium within each optical transmission recess.

16. The optical fiber assembly of claim 15, wherein the optically transmitting medium is an optically transmitting adhesive to secure the optical fibers to the lens plate.

17-24. (canceled)

25. The optical fiber assembly of claim 15, wherein each alignment socket includes at least one channel along the alignment section configured to permit the optically transmitting medium to pass therethrough.

26-28. (canceled)

29. The optical fiber assembly of claim 15, wherein each optical fiber has a diameter, the second lateral alignment section has a depth, and the depth of the second lateral alignment section is at least approximately one-third of the diameter of the optical fiber.

30. The optical fiber assembly of claim 15, wherein each optical fiber has a diameter, the second lateral alignment section has a depth, and the depth of the second lateral alignment section is at least approximately one-half of the diameter of the optical fiber.

31-32. (canceled)

33. The optical fiber assembly of claim 15, wherein the second lead-in section is adjacent the rear face of the body, and the second lateral alignment section extends from the second lead-in section to the stop surface.

34. The optical fiber assembly of claim 33, wherein the second lateral alignment section is deeper than the second lead-in section.

35. The optical fiber assembly of claim 15, wherein each lens element and an aligned optical fiber alignment socket define an optical axis, and an axis of each optical fiber is aligned within approximately one degree of angularity relative to the optical axis.

36. The optical fiber assembly of claim 35, wherein each optical fiber has a diameter and a lateral offset of the optical fiber axis relative to the optical axis of the alignment socket in which the optical fiber is positioned is less than approximately 1.2% of the diameter of the optical fiber.

37. The optical fiber assembly of claim 35, wherein each optical fiber has a diameter and a lateral offset of the optical fiber axis relative to the optical axis of the alignment socket in which the optical fiber is positioned is less than approximately 1.5 μm.

38-39. (canceled)

40. The optical fiber assembly of claim 15, wherein each optical fiber has a diameter and each second lateral alignment section has a depth, and the depth is at least approximately four times the diameter.

41. The optical fiber assembly of claim 15, wherein each optical fiber has a proximal end, the optical fiber having a first diameter substantially along the length thereof, and the proximal end having a second diameter larger than the first diameter.
